(19) United States
(12) Patent Application Publication
(10) Pub. No.: US 2012/0206372 A1
(43) Pub. Date: Aug. 16, 2012

(54) METHOD AND SYSTEM FOR FLEXIBLE USE OF TABLET INFORMATION HANDLING SYSTEM RESOURCES

(76) Inventors: Kevin Mundt, Austin, TX (US); Ayedin Nikazm, Austin, TX (US)

(21) Appl. No.: 13/024,832

(22) Filed: Feb. 10, 2011

(51) Int. Cl. G06F 3/041

(52) U.S. Cl. 345/173

(57) ABSTRACT

A primary information handling system and tablet information handling system interact through a tablet docking station to allocate processing and display resources between each other for an improved end user experience. The tablet display is used as a secondary display of the primary information handling system for presenting information generated by the primary information handling system. A remote desktop protocol executing on the primary information handling presents information generated at the tablet information handling system through the primary system display and allows the end user to interact with applications of the tablet system through I/O devices of the primary information handling system.

### BACKGROUND OF THE INVENTION

1. Field of the Invention

The present invention relates in general to the field of information handling system interactions, and more particularly to a method and system for flexible use of tablet information handling system resources.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As processing components used to build information handling systems have increased in capability and decreased in size, end users have migrated towards adoption of portable information handling systems. Portable information handling systems have an integrated I/O device and power supply so that end users can interact with the system independent of any external peripheral or power cable connections. For example, a conventional clam shell configuration has a housing and rotationally coupled lid that opens to expose a keyboard in the housing and display in the lid and closes to provide a compact portable configuration. Some portable information handling systems have a tablet configuration in which the display includes a touchscreen that presents a keyboard to accept end user inputs. End users find the tablet configuration convenient to handle and use, although the smaller size typically used for a tablet housing means that the processing components used in a tablet usually have less processing capability relative to other types of information handling systems.

One disadvantage of a tablet information handling system is that entering information at a touchscreen keyboard is often tedious and difficult. For this reason, tablet devices are typically used as content consumption devices that are optimized for viewing content through a browser interface or similar viewing portal rather than for data input by typing. Because tablet systems typically have limited processing capability, they are not typically used for computationally complex activities, such as data manipulation. When faced with content creation tasks that require data input or manipulation, end users prefer to use a conventional keyboard and thus avoid using tablet information handling systems. Indeed, tablet information handling systems often do not include content creation applications, such as Word, Excel and PowerPoint. Thus, most tablet information handling users also have a more conventional information handling system to perform data intensive computing tasks. One alternative is to interface a tablet information handling system to a docking station that includes a keyboard and mouse to aid data input to the tablet system. However, such a docking station is of little practical use when an end user also has a conventional information handling system available because the end user will tend to rely upon the conventional system for data input and manipulation if the conventional system is at least as available as the docking station. Therefore, the tablet information handling system will have unused resources unless the end user is unable to access the conventional information handling system.

### SUMMARY OF THE INVENTION

Therefore a need has arisen for a system and method which makes tablet information handling system resources available for use through a conventional information handling system.

In accordance with the present invention, a system and method are provided which substantially reduce the disadvantages and problems associated with previous methods and systems for using the resources of a tablet information handling system when in a docking station. Tablet information handling system resources are made available for use by a conventional information handling system through a docking station that interfaces with the tablet information handling system. I/O devices of the primary and tablet information handling systems adapt to applications independent of the platform running the applications.

More specifically, a primary information handling system interfaces with a tablet information handling system through a serial interface, such as a USB interface supported through a docking station of the tablet information handling system. A display selector of the tablet system detects the primary system and selectively presents visual information of the tablet system at the tablet display or allows the primary system to use the tablet display as a secondary display of the primary system. The primary information handling system includes an RDP client that allows applications running on the tablet information handling system to use I/O devices of the primary information handling system, such as by display visual information of an application running on the tablet system at the display of the primary system and accepting end user inputs for the application running on the tablet system through the keyboard of the primary system. An HID module on the primary system allows touchscreen inputs at the tablet display to a user interface generated by the primary system.

The present invention provides a number of important technical advantages. One example of an important technical advantage is that resources of a tablet information handling system are available for use when the tablet information handling system is docked. For example, the display of the tablet information handling system becomes a secondary display for a conventional information handling system interfaced with the docking station. Applications and data of the tablet information handling system are accessible through the I/O devices of the conventional information handling system to provide increased ease of use when the tablet is docked. The tablet touchscreen becomes available as an extra I/O device for use by the conventional information handling system. Thus, rather than sitting idle in a docking station, a docked tablet information handling system becomes a tool available to improve and end user's experience.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a primary information handling system and tablet information handling system configured to share resources for presenting information to an end user; and

FIG. 2 depicts examples of presentations of visual information through a primary display and a tablet display.

### DETAILED DESCRIPTION

A primary information handling system and tablet information handling system share resources to improve an end user's experience when cooperative computing is available. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

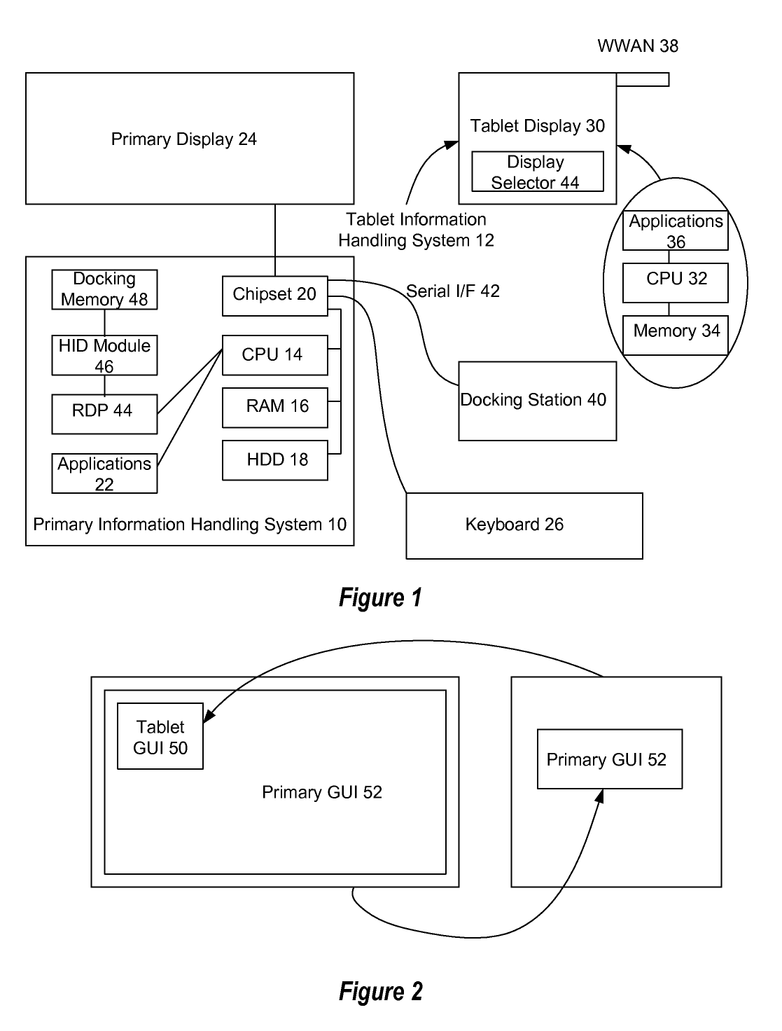

Referring now to FIG. 1, a block diagram depicts a primary information handling system 10 and tablet information handling system 12 configured to share resources for presenting information to an end user. Primary information handling system 10 processes information with plural processing components, such as a CPU 14, RAM 16, HDD 18 and chipset 20 that cooperate to perform processing tasks. For example, CPU 14 executes applications 22 to generate visual information for presentation at a display 24. End users interact with the application through other I/O devices, such as a keyboard 26 or mouse. Tablet information handling system 12 has a portable configuration with a rectangular housing 28 and an integrated touchscreen display 30. Beneath tablet display 30 plural processing components process information within housing 28, such as a CPU 32 and memory 34 that cooperate to execute tablet applications 36. For example, applications 36 execute on CPU 32 to generate visual information for presentation as images at tablet display 30, including a user interface that accepts user touches to tablet display 30 as inputs through the touchscreen. Tablet information handling system 12 includes wireless networking, such as through a wireless wide area network antenna 38 that communicates through a cellular telephone network. Tablet information handling system 12 docks in a docking station 40 that charges an internal battery.

Although tablet information handling system 12 is designed for information consumption rather than data input, in a docked configuration with docking station 40, the resources of tablet information handling system cooperate with primary information handling system 10 to provide greater flexibility of use for both systems. Docking station 40 interfaces a docked tablet information handling system 12 with the processing components of primary information handling system 10 through a serial interface 42 with chipset 20, such as a USB, eSATA or DisplayPort cable. In alternative embodiments, tablet display 30 may couple directly to primary information handling system 10 through serial interface 42 instead of through a docking station 40. When docked in docking station 40 and interfaced with primary information handling system 10, tablet display 30 becomes available as a secondary display of primary information handling system 10, such as might be supported with unintelligent secondary displays under the WINDOWS operating system. For example, an end user can drag application windows, such as Communicator or Outlook windows, from primary display 24 and drop the windows in tablet display 30, thus reserving space on primary display 24 for other content, such as Word or Excel documents. This extended display functionality is automatically implemented with a display selector 44 on tablet information handling system 12 and conventional operating system display management. Display selector 44 is, for example, hardware code/decode or software instructions executing on CPU 32 that disengages tablet display 30 from presenting locally generated visual information to act instead as a secondary display of primary information handling system 10 to present information generated at primary information handling system 10. When a hardware code/decode solution is used to implement display selector 44, tablet CPU 32 remains available to execute applications as set forth below. Display selector 44 can automatically place tablet display 30 in a secondary display mode when an interface is detected with primary information handling system 10 or may respond to end user selections as to the desired display mode so that information generated at tablet information handling system 12 is presented at table display 30 when interfaced with primary information handling system 10.

In addition to sharing display resources, interfaced primary information handling system 10 and tablet information handling system 12 can share processing resources. For example, an end user who desires to access tablet applications 36 through serial interface 42 may do so through I/O devices of primary information handling system 10, such as keyboard 26 or primary display 24. This allows an end user to have the convenience of the large display and physical keyboard of primary system 10 to interact with applications 36 instead the generally smaller tablet display 30 with its virtual keyboard and touchscreen. A remote desktop protocol (RDP) client running on primary information handling system 10 provides access through serial interface 42 to the content, applications and WWAN connectivity of tablet information handling system 12. In this way, the experience of working with tablet information handling system 12 is transferred to the better I/O devices of primary information handling system 10. For example, an end user who docks a tablet information handling system has RDP client 44 to interact with applications 36 running on tablet CPU 32 so that the end user can run mail accounts or browsers at tablet system 12 using WWAN 38 with I/O devices of primary information handling system 10. RDP client 44 executes so that data on tablet system 12 is only displayed at primary display 24, leaving private user content on tablet system 12 without storing the tablet content on primary information handling system 10.

During docked operations, applications 22 running on primary CPU 14 are presented at tablet display 30 by display selector 44 and have the ability to accept inputs through touches with an HIS module 46 running on primary information handling system 10. Touches made by an end user at tablet display 30 are provided through serial interface 42 to HID module 46 and applied as inputs to the associated application. For example, an end user can display a number pad at tablet display 30 and inputs numbers to a spreadsheet displayed at primary display 24 where both the spreadsheet application and number pad application are executing on primary information handling system 10's CPU 14. Since end user's are likely to dock and undock tablet display 30 frequently at docking station 40, a docking memory 48 stores the configuration of the interaction between primary information handling system 10 and tablet information handling system 12 and restores the configuration upon re-docking of tablet system 12. In this way, a user need not re-establish the position of windows on each display at each docking and undocking.

Referring now to FIG. 2, examples of presentations of visual information through a primary display and a tablet display are depicted. Primary display 24 presents both at tablet graphical user interface 50 and a primary graphical user interface 52. Tablet display 30 presents a primary graphical user interface 52. By sharing resources, primary information handling system 10 is enabled to present visual information as images at both displays while tablet information handling system simultaneously executes an application that presents information in tablet graphical user interface 50 at primary display 24. An application running on primary information handling system 52 accepts inputs at the touchscreen of tablet display 30 through primary graphical user interface 52. An application running on tablet information handling system 12 and presented at primary display 24 through tablet graphical user interface 50 accepts inputs at a keyboard 26 or primary information handling system 10. Sharing resources provides the end user with an improved user experience by adapting I/O devices to interact with applications independent of the underlying platform that is running the applications.

Although the present invention has been described in detail, it should be understood that various changes, substitutions and alterations can be made hereto without departing from the spirit and scope of the invention as defined by the appended claims.

What is claimed is:

1. An information handling system comprising:
a fixed housing;
processing components disposed in the housing and operable to generate visual information for presentation at a display as an internal image;
a display integrated in the housing and interfaced with the processing components, the display operable to present the visual information as images and to receive inputs made as touches to the display; and
a display selector interfaced with the display and operable to selectively present at the display one of the internal images or external images generated at an external information handling system.

2. The information handling system of claim 1 wherein the display selector comprises a hardware code/decode function.

3. The information handling system of claim 1 wherein the display selector comprises an application running on a central processing unit processing component.

4. The information handling system of claim 1 further comprising a serial interface in communication with the display selector and operable to communicate the external images from an external information handling system.

5. The information handling system of claim 4 wherein the serial interface comprises a DisplayPort interface.

6. The information handling system of claim 4 wherein the serial interface comprises a USB interface.

7. The information handling system of claim 4 wherein the serial interface comprises a docking station interface.

8. The information handling system of claim 1 wherein the display selector is further operable to selectively communicate the internal images to the external information handling system for presentation at the external information handling system.

9. The information handling system of claim 8 wherein the display comprises a touchscreen and the display selector is further operable to communicate inputs made at the touchscreen to the external information handling system.

10. A method for presenting information as visual images, the method comprising:
executing one or more applications at a primary information handling system to generate primary visual information;
presenting the primary visual information as images at a primary display of the primary information handling system;
interfacing the primary information handling system with a tablet information handling system;
executing one or more applications at the tablet information handling system to generate tablet visual information; and
selectively presenting one of either the primary visual information or the tablet visual information as visual images at a display of the tablet information handling system.

11. The method of claim 10 further comprising:
selecting presentation of the primary visual information at the tablet information handling system display; and
simultaneously selecting presentation of the tablet visual information at the primary display.

12. The method of claim 10 further comprising:
selecting presentation of the primary visual information at the tablet information handling system display;
detecting touches at the tablet information handling system display; and
communicating the touches as inputs to the primary information handling system.

13. The method of claim 10 further comprising communicating the primary visual information to the tablet information handling system through a DisplayPort interface.

14. The method of claim 10 further comprising communicating the primary visual information to the tablet information handling system through a USB interface.

15. The method of claim 10 further comprising communicating the primary visual information to the tablet information handling system through a docking station interface.

16. The method of claim 15 further comprising:
storing a configuration of the tablet visual information presented at the primary display;
disconnecting the docking station interface;
re-connecting the docking station interface; and
automatically applying the stored configuration to re-establish the tablet visual information presented at the primary display.

17. A system for presenting visual information as visual images, the system comprising:
a primary information handling system operable to generate visual information and to present the visual information as visual images at a primary display;
a tablet information handling system operable to generate visual information and to present the visual information as visual images at an integrated tablet display;
a communication interface between the primary information handling system and the tablet information handling system; and
a remote desktop protocol executing on the primary information handling system and operable to present the visual information generated at the tablet information handling system as visual images at the primary information handling system.

18. The system of claim 17 wherein the remote desktop protocol is further operable to accept inputs made at the primary information handling system in response to the visual images associated with the tablet visual information and to communicate the inputs to the tablet information handling system for management by an application executing on the tablet information handling system.

19. The system of claim 17 further comprising a display selector integrated with the tablet information handling system and operable to selectively present at the tablet information handling system display visual images from the primary information handling system visual information instead of visual images from the tablet information handling system visual information.

20. The system of claim 17 wherein the communication interface comprises a docking station operable to dock the tablet information handling system.
